(19) United States
(12) Patent Application Publication
(10) Pub. No.: US 2010/0011290 A1
(43) Pub. Date: Jan. 14, 2010

(54) Print management method, recording medium storing a program, and print management apparatus

(75) Inventor: Kotaro Kaneko, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Konica Minolta Business Technologies, Inc., Tokyo (JP)

(21) Appl. No.: 12/458,077

(22) Filed: Jun. 30, 2009

Related U.S. Application Data
(63) Continuation of application No. 11/272,819, filed on Nov. 15, 2005.

(30) Foreign Application Priority Data
Aug. 5, 2005 (JP) 2005-228106

(51) Int. Cl. G06F 17/00; G06F 17/30

(52) U.S. Cl. 715/273; 707/100; 707/E17.005

(57) ABSTRACT

Disclosed is a print management method includes: managing a printing condition of a plurality of files created by at least one application program; and controlling an instruction for print execution corresponding to the at least one application program according to the printing condition when performing print output of the plurality of files.

### BACKGROUND OF THE INVENTION

1. Field of the Invention

The present invention relates to a print management method, a recording medium storing a program, and a print management apparatus.

2. Description of Related Art

Currently, various kinds of application programs (hereinafter abbreviated as “application” accordingly) such as software for word-processing, software for spreadsheet, software for image editing, software for presentation, and the like are disseminated. A document, a graph, or the like, created or edited by these applications, are stored as a file in a data form on an application basis. For example, when printing document and graph for a conference material use, each of the files are printed by a printer (printing apparatus), by initiating individually the software for word-processing and the software for spreadsheet, opening the file corresponding to each application, and performing print instruction individually.

Further, as a method to manage a print processing of each file by a job form specific to the printer, binding a plurality of jobs into one job to perform print output is known in the conventional art. By performing file management of job form at the printer, in case printing a plurality of files in an organized way, printing only necessary pages, setting detailed print setting for each page, or the like can be achieved. Additionally, when printing a plurality of files (document data) created by different application, binding the plurality of files before hand into an object called “binder” to achieve printing the file contained in the binder is known in the conventional techniques. (JP-2001-84246A, hereinafter referred to as “patent reference 1”)

However, when printing a part of pages from different files in organized way by utilizing the art of the patent reference 1, cumbersome procedures such as destructing: unnecessary page after printing and editing each file before printing will be needed. Since print settings such as duplex printing, stapling, and the like are related to the printer, the print settings will be applied to entire binder in the patent reference 1. Therefore, when changing the print settings for every file, a user ends up having to initiate application and to change the print settings individually.

As described above, by file managing job form at the printer, printing necessary pages, changing print settings for each page, or the like can be achieved. However, various kinds of files sent from a terminal device will be converted into a data form specific to the printer, by a printer driver and the like. Accordingly, original file will be lost at the printer, and it cannot be re-converted into original data form. It is possible that the original file can be lost also in the art described in patent reference 1, since each file is handled as the object called “binder”. Therefore, when changing settings for each page or re-editing a file, user has to re-initiate the application, change the print settings or re-edit the file, perform print instruction, and perform managing setting for the job at the printer. Accordingly, operation at the terminal device and the printer has to be both performed, which causes a very cumbersome workload.

### SUMMARY

The present invention has been made to solve the above problems. An object of the invention is to improve operability when performing print output of a plurality of files created by application program.

In order to solve the above problems, according to an embodiment reflecting one aspect of the invention, the print management method comprises:

managing a printing condition of a plurality of files created by at least one application program; and

controlling an instruction for print execution issued from the at least one application program according to the printing condition, when performing print output of the plurality of files.

The at least one application program created the plurality of files and the at least one application program issuing the instruction for print execution are preferably identical each other in version; however, they may be different in version or may be compatible programs each other.

Preferably, the printing condition is set for each of the plurality of files.

Preferably, the printing condition includes print setting information of the plurality of files.

Preferably, the printing condition includes a printing order when the plurality of files are subjected to print output.

Preferably, the printing condition is changed based on the user's change operation.

### BRIEF DESCRIPTION OF THE DRAWINGS

The present invention will become more fully understood from the detailed description given hereinafter and the accompanying drawings which are given by way of illustration only, and thus are not intended as a definition of the limits of the scope of the invention, and wherein:

FIG. 1 is a block diagram showing an example of a system structure of a print management system and an example of a function structure of each apparatus;

FIG. 2A is a view showing an example of a data structure of an entire setting data;

FIG. 2B is a view showing an example of a data structure of an individual print setting data;

FIG. 3 is a flow chart to explain specific steps within an organized printing function of a printer server;

FIG. 4 is a flow chart to explain specific processing steps within print processing;

FIG. 5A is a view showing an example of a display of a log in screen at a user terminal;

FIG. 5B is a view showing an example of a display of an organized printing listing screen at the user terminal;

FIG. 6A is a view showing an example of a display of file selecting screen at the user terminal;

FIG. 6B is a view showing an example of a display of file listing screen at the user terminal;

FIG. 7 is a view showing an example of a display of a detail setting screen at the user terminal;

FIG. 8 is a view showing an example of execution result of the organized printing; and

FIG. 9 is a view showing an example of data structure of the entire setting data within an example of modification.

### DETAILED DESCRIPTION OF THE PREFERRED EMBODIMENTS

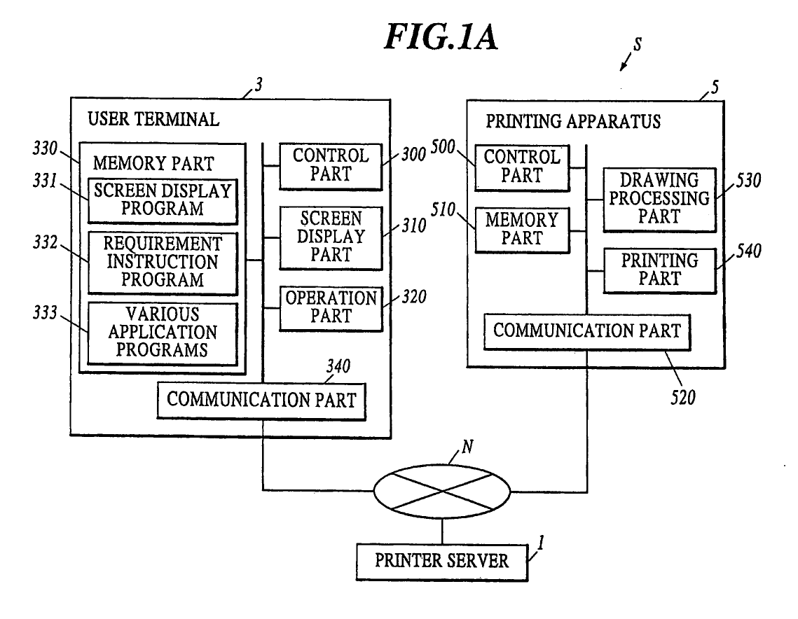

An embodiment of a print management system provided with a printer sever, wherein a print management apparatus of the present invention is applied to the printer server, will be described below with reference to FIGS. 1 to 9.

First of all, a system structure of a print management system S will be explained. As shown in FIG. 1, the print management system S comprises a printer server 1, a user terminal 3, a printing apparatus 5 such as copying machine, facsimile, printer, complex machine combined with the mentioned devices, and the like. These are structured connectively through a communication circuit N such as LAN, public circuit web and the like, and are capable to exchange data.

A user initiates various kinds of applications at the user terminal 3, creates a file of document, graph, or the like, and performs print instruction of the file. The file which was subject to a print instruction at the user terminal 3, is sent to printing apparatus 5 through printer server 1, and print output is performed.

Printer server 1, based on the print instruction from the user terminal 3, carries out a scheduling and a file management when printing. Particularly in this embodiment, pages for print output, print settings, and the like can be set for each file individually, achieving “organized printing” function that perform print output for the plurality of files at one time. Within this organized printing, when performing print output for the plurality of files created by various kinds of applications in an organized way, printing only the necessary pages and changing the settings, such as size of a paper, duplex printing, stapling, and the like, can be performed individually.

Next, a functional structure of each apparatus structuring the print management system S will be explained with reference to FIG. 1. The user terminal 3 comprises a control part 300, a screen display part 310, an operation part 320, a memory part 330, and a communication part 340.

The control part 300 comprises CPU (Central Processing Unit), ROM (Read Only Memory), RAM (Random Access Memory), and the like. The control part 300 is a functional part which executes processing according to the predetermined program based on an instruction inputted, gives instruction to various kinds of function parts, inputs and outputs data, thus controls the user terminal 3 comprehensively. Particularly, the CPU reads a program installed in the ROM and memory part 330 and the like upon power-on or based on operation signal inputted from operation part 320, and displays result of a processing corresponding to the program, on the screen display part 310.

The screen display part 310 comprises CRT (Cathode-ray Tube), LCD (Liquid Crystal Display), and the like, and outputs display for various kinds of screen according to display data inputted from control part 300. Operation part 320 is provided a keyboard with a cursor key, a numeric keypad, or other various kinds of functional keys, a pointing device such as a mouse or the like. The operation part 320 outputs operation signals, such as depression signal of a depressed key and position signal of mouse, to the control part 300. The communication part 340 is a function part to exchange data by connecting to communication circuit N, and is provided with modem, LAN interface, USB, and the like.

The memory part 330 is a function part to read and write data in a memory medium such as CD-ROM, memory card, hard disk, and the like. The memory medium is structured with magnetic or optic memory medium, or a semiconductor memory, and stores data and the like, processed by application program and various kinds of processing programs.

According to FIG. 1, memory part 330 stores a screen display program 331, a requirement instruction program 332, and various kinds of application programs 333 such as word-processing software, spreadsheet software, image editing software, and the like. The screen display program 331 is a program to control displaying various kinds of screens such as a file selecting screen 420, a detail setting screen 440 and the like on a screen display part 310. The requirement instruction program 332 is a program to receive requirement instruction of the user from the operation signal of the operation part 320, or receive requirement instruction from the printer server 1. The control part 300, corresponding with the requirement instruction program 332 and screen display program 331, displays display screen based on the operation of the operation part 320 by the user, and displays display screen according to a display data sent from the printer server 1.

Additionally, the control part 300 initiates application program 333 based on the user's operation, and creates document file, graph file, and the like. At this time, an extension based on the application is added to a file name of each file, and application program 333 for creating the file can be identified according to the extension. For example, when the extension is “aaa”, it is a document file created by word processing software, when the extension is “bbb”, it is a graph file created by spreadsheet software. The control part 300 sends the created or edited file to the printer server 1, and stores it in a data memory part 50 of the printer server 1.

A printing apparatus 5 is provided a control part 500, a memory part 510, a drawing processing part 530, a printing part 540, and a communication part 520. The control part 500 is a function part comprising CPU, ROM, RAM and the like, and executes processing according to the predetermined program, gives instruction to various kinds of function parts, inputs and outputs data, thus controls the user terminal 3 comprehensively.

The memory part 510 is a function part to read and write data in a memory medium such as V-RAM (Video RAM), memory card, hard disk, and the like. The memory medium is structured with magnetic or optic memory medium, or a semiconductor memory, and stores file and the like sent from the printer server 1.

The drawing processing part 530 is structured with CPU, DSP (Digital Signal Processor), and the like, and converts the file stored in the memory part 510 into an image data in a data form specific to the printing apparatus 5, performs various kinds of image processing, and then sends it to the printing part 540, according to the instruction from the control part 500.

The printing part 540 is a function part to form an image on a transfer paper. The printing part 540 expose scans a sensitizing drum by a laser beam radiated from an exposing part, and forms an electrostatic latent image according to an image data outputted from the drawing processing part 530. Subsequently, a developing material is absorbed on the sensitizing drum at developing part, transferred to a transfer paper, and then toner is heat fused on the transfer paper at a fusing part, thus forming an image. The communication part 520 is a function part to exchange data by connecting to communication circuit N, and is structured provided with modem, LAN interface, USB, and the like.

The printer server 1 is structured provided with a control part 10, a print instructing part 20, a program memory part 40, a data memory part 50, and a communication part 30.

The control part 10 is a function part comprising CPU, ROM, RAM and the like, and executes processing according to the predetermined program, gives instruction to various kinds of function parts, inputs and outputs data, thus controls the printer server 1 comprehensively.

The print instructing part 20 is a function part to control communication with the printing apparatus 5, wherein the control part 10 initiates an application program 41 and performs instruction to the printing apparatus 5, to perform print execution of the file read from file memory part 51.

The communication part 30 is a function part to exchange data by connecting to communication circuit N, and is structured provided with modem, LAN interface, USB, and the like.

The program memory part 40 is structured with nonvolatile memory capable to read and write, such as ROM and the like, and stores program necessary to perform the printer server 1, data related to execute such program, and the like. In FIG. 1, the program memory part 40 stores various kinds of application programs 41 and a requirement control program 42.

The various kinds of application programs 41 are programs equal to various kinds of application programs 333 stored at the user terminal 3, such as word-processing software, spreadsheet software, image editing software, and the like.

The requirement control program 42 is a program to achieve request control function that performs each task processing by reading a subroutine based on the requirement from the user terminal 3. The subroutine of the requirement control program 42 comprises a print management program 43, a display screen control program 44, a user management verifying program 45, and an application control program 46.

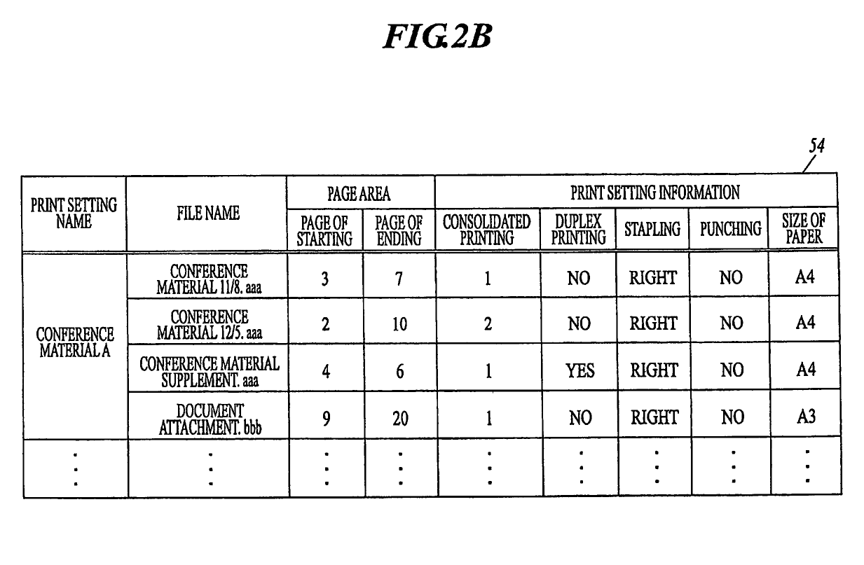

The print management program 43 is a program to achieve print management function that stores various kinds of files that were sent from the user terminal 3, in a file memory part 51, manages print setting and the like for each file, instructs printing, and the like. The screen display control program 44 is a program to control the screen to be displayed on a screen display part 310 of the user terminal 3. The user management verifying program 45 is a program to manage or verify an access authority of the user. The application control program 46 is a program to automatically control application corresponding to various kinds of files created by user terminal 3. Within the association of these subroutines, processing shown in FIG. 3 is achieved.

The data memory part 50 is a function part to read or write data in the memory medium such as memory card, hard disk, and the like. In FIG. 1, the data memory part 50 is structured provided with a file memory part 51, a printing condition memory part 52, and a user data memory part 55.

The file memory part 51 is a data area to store various kinds of file bodies created by application of user terminal 3, and copy of a file added by the user in organized printing. The control part 10, in case of organized printing, updates the copied file corresponding to an editing operation by the user, and reflects edition to the copied file when update button 447 is clicked.

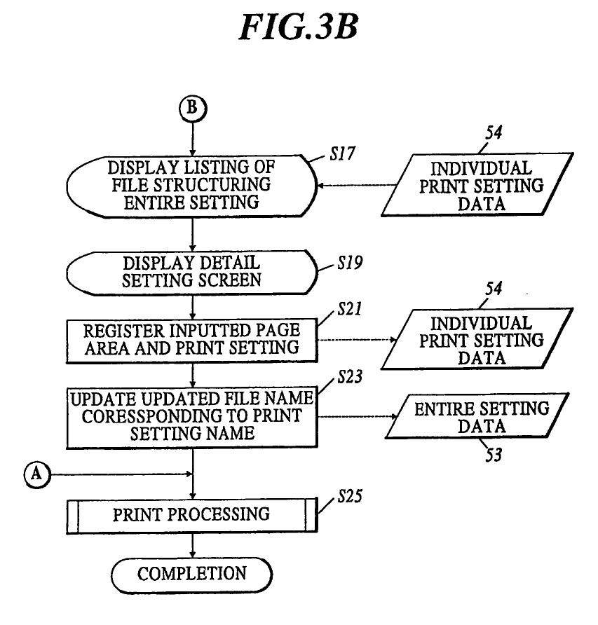

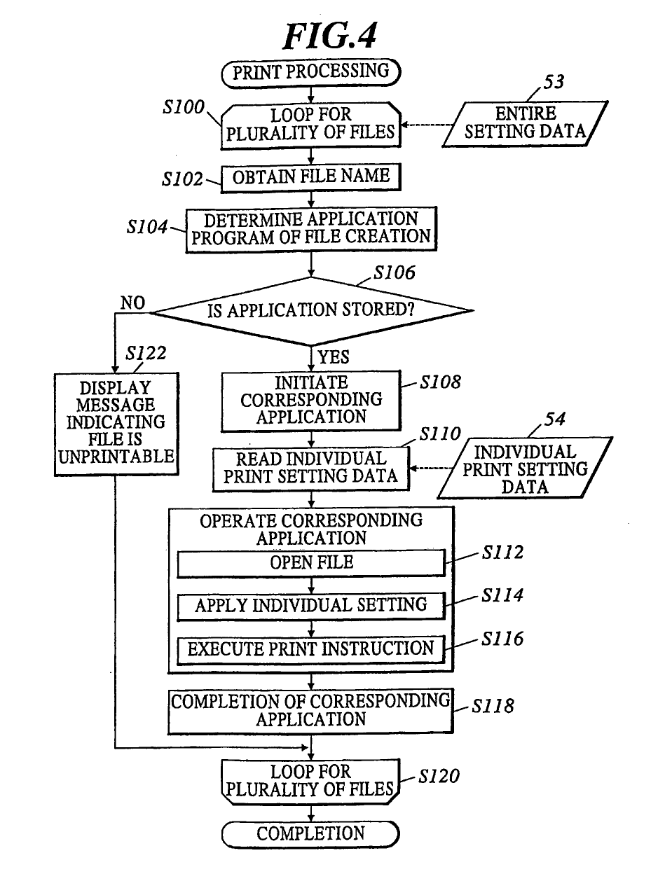

The user data memory part 55 is a data area to store in association with a password for each user ID. The control part 10 verifies whether the user has authority to use organized printing function by comparing the user ID inputted from a log in screen 400 as shown in FIG. 5A and password, with data stored in the user data memory part 55.

The printing condition memory part 52 is a data area to store printing condition for organized printing, and stores an entire setting data 53 and an individual print setting data 54.

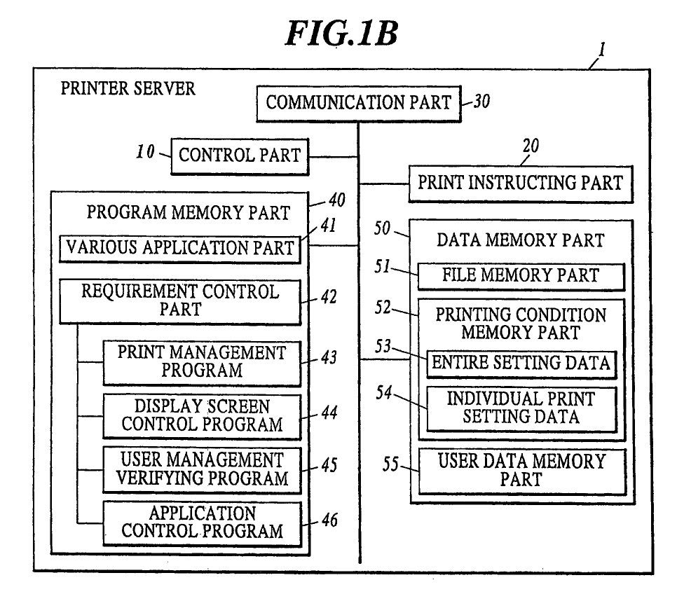

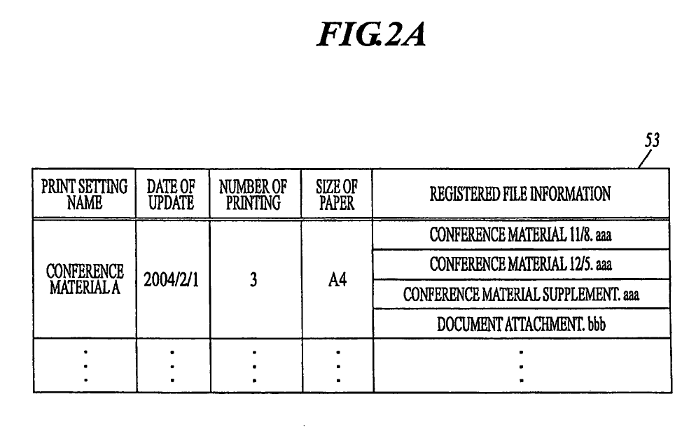

The entire setting data 53 is a data table to manage a plurality of files individually as one print unit in case of organized printing, and stores print setting name, date of update, number of printing, size of paper, and registered file name in association as shown in FIG. 2A of an example of data structure. The print setting name is a name for identification, named for the entire plurality of files added or selected by the user in case of organized printing, and is inputted by the user. The date of update is a date when number of printing, registered file information, or the like corresponding to the print setting name has been updated, and is set by the control part 10. The registered file name is a file name of an added file in case of organized printing.

The control part 10 stores, regarding the print setting name inputted by the user in organized printing, a file name of an added file in association with the registered file name. For example, in data structure of FIG. 2A, four files, “conference material 11/8.aaa”, “conference material 12/5.aaa”, “conference material supplement.aaa”, and “document attachment.bbb” are added to the print setting name “material for conference A”, and the entire added file is to be performed print output in A4 sized paper in triplicate.

Therefore, since instruction for print execution is performed according to plurality of printing conditions set for each file, plurality of files can be performed print output without initiating application program for each file.

The individual print setting data 54 is a data table to manage each file added in case of organized printing, and to store print setting name, registered file name, page area including pages for starting and ending, and print setting information in association. The print setting information is setting information to perform print output of a file associated with a registered file name, and includes number of pages for consolidated printing which prints a plurality of pages on one transfer paper, duplex printing, presence of request for stapling or punching, and the size of paper. The size of paper in individual print setting data 54 is the same as the paper size in the entire setting data 53 by default, and can be changed for each file individually by the user.

Therefore, since instruction for print execution is controlled according to printing condition containing print setting information in the file, plurality of files can be performed print output by different print setting information. Additionally, since the printing condition is changed based on a change operation from the user, the user can set the desired printing condition.

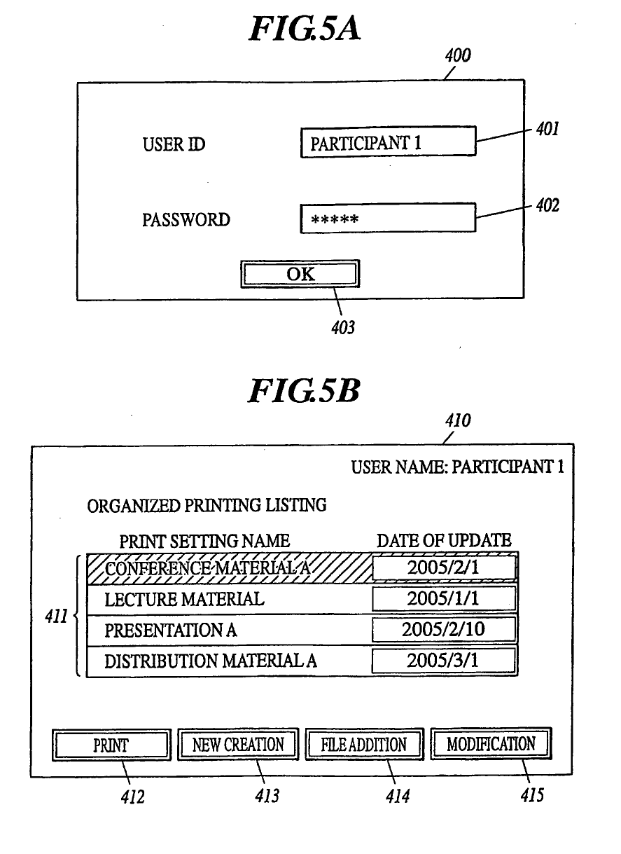

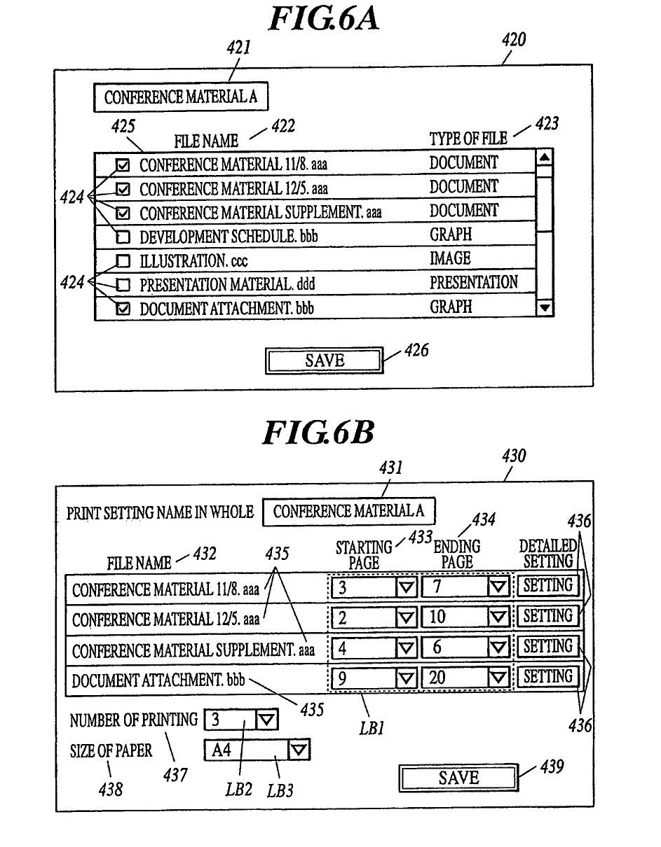

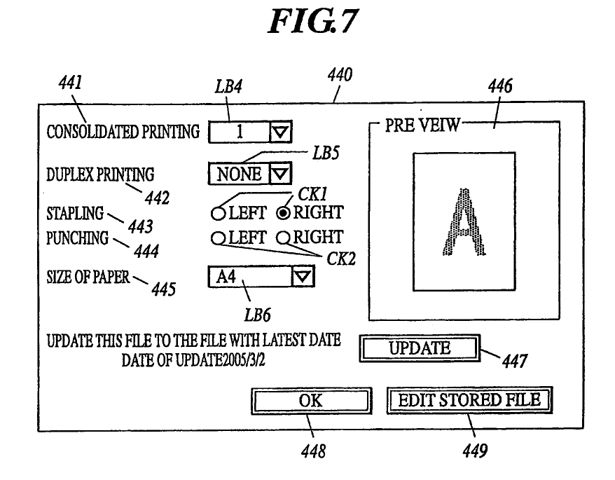

The control part 10 manages printing condition of a plurality of files by creating and adding page area and print setting information, in association with print setting name and registered file name, each time a file is added for organized printing. Additionally, in case change operation to change page area or print setting information is done by the user using a list box and a check box of a file listing screen 430 shown in FIG. 6B and a detail setting screen shown in FIG. 7, page area or print setting information of individual print setting table 54 is changed and updated based on the change operation. In FIG. 2B, for example, registered file name “conference material 12/5.aaa” is to be performed print output from page 2 to page 10, and 2 pages are to be consolidated on one transfer paper.

Here, this entire setting data 53 and individual print setting data 54 may adopt appropriate conventional technology. The technology shall be, by using print setting name or file name or the like as a search key, capable to search and update corresponding various kinds of information, such as chart form (table form) shown in FIG. 2, layered system, data base system in XML form, or the like. Additionally, storage location (file pass, for example) in file memory part 51 can be stored as a file name.

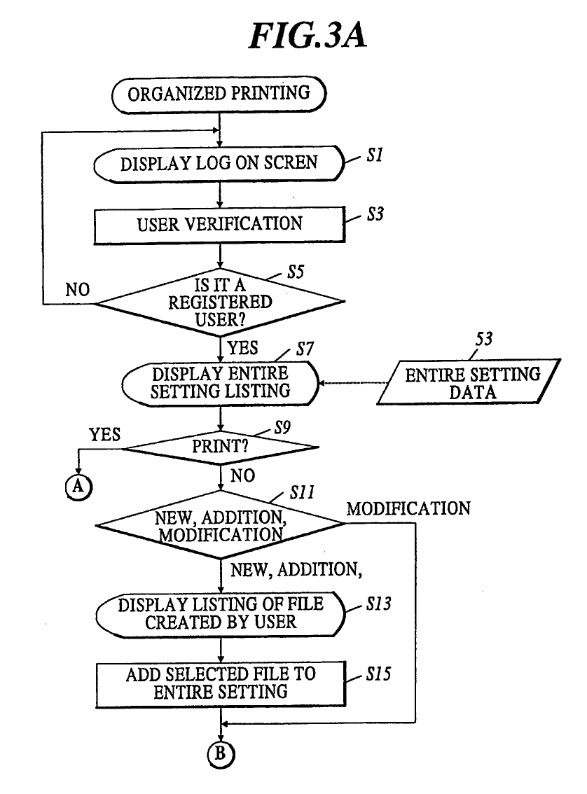

Next, specific processing steps at the printer sever 1 is described with reference to examples of display screen shown in FIGS. 4-7, and flow charts shown in FIGS. 3 and 4.

When control part 10 of printer server 1 detects a requirement of starting instruction for organized printing from the user terminal 3 through a communication part 30, it displays a log in screen 400 as shown in FIG. 5A on the user terminal 3 (step S1). When the user inputs user ID and password into ID area 401 and password area 402 respectively, and then clicks OK button 403 by a mouse, user verification is requested from the user terminal 3, and then the control part 10 verifies the user according to data stored in user data memory part 55 (step s3).

Subsequently, if it is verified that the user is an already registered user (step 5; Yes), entire setting data 53 is read from printing condition memory part 52 and organized printing listing screen 410 (shown in FIG. 5B), including print setting name and date of update in the data as a listing list 411, is displayed on the user terminal 3 (step S7). The print setting name in this listing list 411 is selectable by operation from the user's operation part 320, and the selected print setting name is displayed in a reverse form (i.e., highlighted) as shown in FIG. 5B.

When the control part 10 detects that printing button 412 of organized printing listing screen 410 has been clicked (step S9; Yes), print processing (shown in FIG. 4) as described later is performed by moving on to step S25. In contrast, when file addition button 414 has been clicked (step S11; addition), file selecting screen 420 as shown in FIG. 6A is displayed according to various kinds of kinds of files and entire setting data 53 stored in file memory part 51 (step S13).

In particular, file stored in file memory part 51, that is, file name 422 of a file created by the user at the user terminal 3, type of file 423 determined from extension included in the file, and file listing 425 including check box 424 are displayed. Then the registered file name corresponding to the print setting name selected in the organized printing listing screen 410 is read from the entire setting data 53, and the check box of the file name is checked.

Additionally, when it is detected that new creation button 413 has been clicked in step S11 (step S11; new), the control part 10 displays file selecting screen 420 with print setting name area 421 and check box 424 cleared (step S13). Then, after processing step S13, file selection of the user is received from the file selecting screen 420 (step S15).

When control part 10 detects that modification button 415 has been clicked in step S11, or when processing of step S13 has completed, control part 10 reads the registered file name and the page area corresponding to the print setting name selected at organized printing listing screen 410, from the individual print setting data 54, and displays a file listing screen 430 shown in FIG. 6B on the user terminal 3 (step S17). The user can change starting page 433, ending page 434, number of printing 437, and size of paper 438 by operating list boxes LB1, LB2, LB3 on the file listing screen 430.

When detail setting button 436 on the file listing screen 430 has been clicked, print setting information of the file name corresponding to the clicked button is read from the individual print setting data 54, and displayed on detail setting screen 440 shown in FIG. 7 (step S19). At this time, a print image when printed according to the print setting information stored in the individual print setting data 54 is displayed in a pre-view area 446.

The user can change consolidated printing 441, duplex printing 442, and size of paper 445 by operating list boxes LB4, LB5, LB6. Additionally, the user can change presence of request for stapling 443 or punching 444 by operating checkboxes CK1 and CK2. When edit button 449 in detail setting screen 440 is clicked, the control part 10 determines an application program 41 of the file creation, according to the extension included in the registered file name. Then the file is read by the determined application program 41 and is displayed on the user terminal 3, ready for edition by the user. Additionally, when it is detected that update button 447 has been clicked, the aforementioned file which is the origin of replication is updated with edited content.

When control part 10 detects that save button 439 in file listing screen 430 and “OK” button 448 in detail setting screen 440 has been clicked, page area changed or set and print setting information are stored in the individual print setting data 54 for each registered file name, in their respective screens (step S21). Subsequently, file name of files selected in the file selecting screen 420 are stored and updated in an order by their names, corresponding to the entire setting data 53 (step S23), and moves on to print processing shown in FIG. 4 (step S25).

When print processing is started, the control part 10 reads registered file name which corresponds to the print setting name selected by the user, from the entire setting data 53, and enters a loop (steps S100-S120) which performs sequential printing for each file of the registered file name.

First of all, registered file name corresponding to the print setting name selected by the user is obtained from the individual print setting data 54 (step S102), and application program of the file creation, according to the extension included in the registered file name is determined (step S204). Subsequently, determination is made on whether the application program is stored in the program memory part 40 (step S106), and when it is not stored (step S106; No), a message indicating that the file is unprintable is displayed on the user terminal 3 (step S122), and obtains next registered file name (step S102).

In step S106, when it is determined that application program is stored in the program memory part 40 (step S106; Yes), the control part 10 initiates the application program 41 (step S108), reads the page area and the print setting information corresponding to the obtained registered file name from the individual print setting data 54 (step S110).

Subsequently, by operating the application program 41, file of the registered file name is opened (step S112), read and applied the page area and print setting information in the individual print setting data 54, and then the applied file is outputted to a print instructing part 20 (step S114). The print instructing part 20 instructs print execution of the file, outputted from the control part 10, to the printing apparatus 5 through communication part 30 (step S116). The control part 10, after closing the initiated application program 41, obtains sequentially all of the registered file names corresponding to the print setting name, repeating the loop of steps S100-S120.

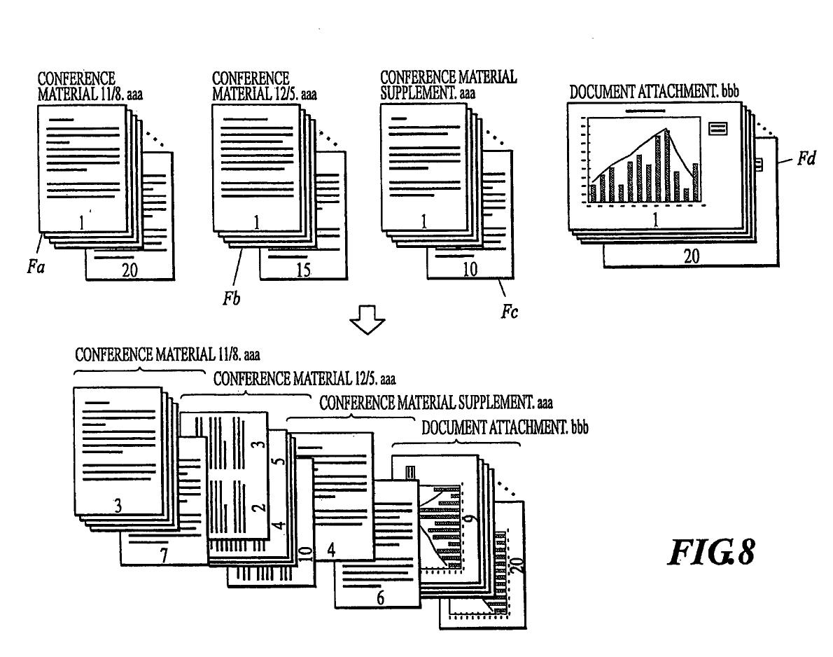

For example, as shown in FIG. 8, when A4 sized document file Fa, Fb, and Fc of “conference material 11/8.aaa”, “conference material 12/5.aaa”, and “conference material supplement.aaa” and A3 sized graph file Fd of “document attachment.bbb” are organized printed, the user first makes selection by turning checkboxes for these files “ON” (step S13 of FIG. 3), in the file selecting screen 420 as shown in FIG. 6A.

Subsequently, as shown in the file listing screen 430 of FIG. 6B, page area for each file is set, detail setting screen 440 is displayed by clicking detail setting button 436 for each file, and print setting information for each file is set. For example, list boxes LB4, LB5, and LB6 are each operated so as to keep file Fa set as default, perform consolidated printing of file Fb by two pages printed on one transfer paper, perform duplex printing of file Fc, and change paper size of file Fd to A4. At this time, by the control part 10, individual print setting data 54 is created with a data structure as shown in FIG. 2B (steps S17-S21 of FIG. 3).

By performing print processing according to this individual print setting data 54, file names “conference material 11/8.aaa”, “conference material 12/5.aaa”, “conference material supplement.aaa” and “document attachment.bbb” are sequentially obtained from the entire setting data 53, and as shown in FIG. 8, print-output for pages 3-7 of file Fa, consolidated printing for pages 2-10 of file Fb, duplex printing for pages 4-6 of file Fc, and reduced printing to A4 size for pages 9-20 of file Fd are sequentially performed.

Therefore, according to the present embodiment, when performing print output of a plurality of files created by application program according to the printing condition, printing instruction is controlled corresponding to the application program that created the file.

Specifically, plurality of files in different data form, created by the user terminal 3 are stored at printer server 1, and in case organized printing for these files is performed, instruction for print execution is performed according to the individual print setting data 54, which stores page area and print setting information for each file.

Therefore, the user can easily perform print output of a plurality of files without the burden of initiating application program for each file. Additionally, since original data of the file that was performed print output will not be lost, setting at the printer is not needed when changing setting for each page or re-editing a file. Accordingly, since each file is managed at printer server 1 without converting the plurality of files into a data form specific to the printing apparatus 5, user can freely edit the file after organized printing.

In addition, since printing is performed for each file according to the individual print setting data 54, setting can be changed individually for each file based on scenes such as conference, presentation, or the like. The setting can also be changed freely after organized printing. Therefore, setting of a plurality of different files can be changed individually, and the user can perform editing or changing individual print setting without the burden of initiating corresponding application for each files. Accordingly, operability when performing print output of a plurality of files can be improved.

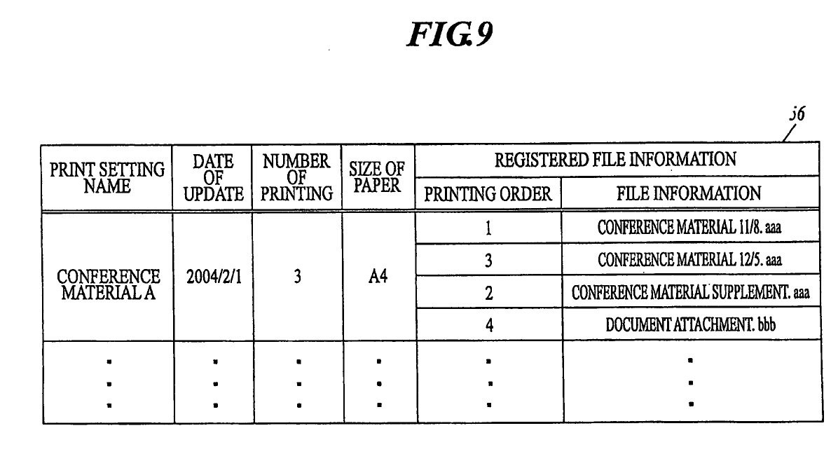

Here, in the above-mentioned embodiment, file names of the files selected by the user is stored in the entire setting data 53 and the individual print setting data 54, within an order (alphabetical order for example) stored in the file memory part 51, and performed print output in that order. However, the order for print output can be changeable. In this case, for each file name of registered file information, an entire setting data 56 stored with correspondence to printing order is structured with the data structure as shown in FIG. 9. Within step S23 of FIG. 3, when file name is being stored, for example, an order, in which file name was selected by the user, is stored as the printing order, and in print processing loop of FIG. 4, execution of print instruction is performed by obtaining file name, corresponding to the printing order.

Additionally, there may be other means to set printing order. For example, printing order setting screen to set printing order of files can be displayed on the user terminal 3, and printing order set in this screen can be stored in the entire setting data 56. Accordingly, print output of file is performed in the order selected by the user. Since instruction for print execution is controlled according the printing condition including printing order when performing print output of the file, printing order for a plurality of files can be previously set.

Additionally, printer server 1 was structured to be a different apparatus to the user terminal 3; however, function of printer server 1 may be incorporated into the user terminal 3, or may be incorporated into the printing apparatus 5, and the system structure of print managing system S can be modified arbitrarily.

The present application is based on the entire disclosure, including the specification, claims, drawings, and abstract, of Japanese Patent Application No. 2005-228106 filed with Japan Patent Office on Aug. 5, 2005.

What is claimed is:

1. A print management method, comprising:
managing a plurality of documents as one print unit; and
assigning individual print setting data to each of the plurality of documents in the one print unit, wherein
the individual print setting data include information indicating page area to be printed as to each of the plurality of documents.

2. The print management method of claim 1, wherein the individual print setting data include a data structure having a layered system.

3. The print management method of claim 1, wherein the individual print setting data include a data structure having a data base system.

4. A computer readable program to realize by a computer:
a management function of managing a plurality of documents as one print unit; and
an assigning function of assigning individual print setting data to each of the plurality of documents in the one print unit, wherein
the individual print setting data include information indicating page area to be printed as to each of the plurality of documents.

5. The computer readable program of claim 4, wherein the individual print setting data include a data structure having a layered system.

6. The computer readable program of claim 4, wherein the individual print setting data include a data structure having a data base system.

7. A print management apparatus, comprising:
a storage section for storing a plurality of documents as one print unit; and
a print instruction section for assigning individual print setting data to each of the plurality of documents in the one print unit, wherein
the individual print setting data include information indicating page area to be printed as to each of the plurality of documents.

8. The print management apparatus of claim 7, wherein the individual print setting data include a data structure having a layered system.

9. The print management method of claim 7, wherein the individual print setting data include a data structure having a data base system.
